(19) United States
(12) Patent Application Publication
(10) Pub. No.: US 2008/0207342 A1
(43) Pub. Date: Aug. 28, 2008

(54) ROTATINGLY DRIVABLE CUTTING HEAD

(75) Inventors: Detlef Adam, Lutau (DE); Roland Wohl, Worth (DE); Andreas Focken, Schwarzenbek (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Fette GmbH, Schwarzenbek (DE)

(21) Appl. No.: 12/028,995

(22) Filed: Feb. 11, 2008

(30) Foreign Application Priority Data
Feb. 28, 2007 (DE) 10 2007 011 336.8

(51) Int. Cl. B23G 5/10; B23B 27/16

(52) U.S. Cl. 470/185; 407/113

(57) ABSTRACT

A rotatingly drivable cutting head with at least one cutting insert, which has a cutting profile tool for radial engagement into a workpiece, the one axis of which is in the rotational axis of the cutting head, wherein cutting head and workpiece are moved axially and in the rotational direction with respect to each other, wherein the cutting insert is detachably attachable on a holding element of the cutting head, wherein further the holding element and with it the cutting insect is radially movable between a working position and a releasing position, and with locking means for positioning the cutting insert in the working position and shifting means for shifting the cutting insert from the working position into the releasing position and vice versa, wherein the cutting insert has an axis which runs parallel to the rotational axis in a distance, the cutting insert is attachable on the holding element in at least two rotational positions in an angular distance when it is rotated around its axis, and in every rotational position, a cutting profile tool is in the working position on the cutting insert.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

It is known to use cutting heads for cutting external threads, which are provided with cutting inserts. It is also known to realise such cutting heads to be self-opening. The workpiece is moved with respect to the cutting head in the axis of the cutting head, and a relative rotation takes place between cutting head and workpiece. After completion of the tapping procedure, the cutting head is opened, i.e. e. the cutting inserts are moved radially towards the outside for a distance with the aid of a suitable mechanism, so that the workpiece can be removed from the cutting head rapidly and without problems.

The cutting inserts are realised such that resharpening takes place after wear of the cutting profile tool. However, resharpening has some disadvantages for the user. For instance, resharpening of the tapping inserts is possible only outside of the cutting head. Resharpening requires sumptuous equipment on the part of the user. After resharpening, the cutting inserts have to be newly adjusted in the tapping head. A possible coating of the cutting insert with a hard material is no more present after resharpening. As the case may be, a fresh coating has to be applied.

It is further known to equip cutting heads with cutting inserts for peeling workpieces, also with indexable inserts, for instance.

The present invention is based on the objective to provide a rotatingly drivable cutting head, wherein resharpening is inapplicable as well as the new adjustment after changing a cutting edge.

### BRIEF SUMMARY OF THE INVENTION

In the present invention, the cutting insert has an axis which runs parallel to the rotational axis in a distance. The cutting insert is attachable on the holding element (34, 44) in at least two rotational positions in an angular distance when it is rotated around its axis, and to each rotational position is assigned a cutting profile tool on the cutting insert.

In the cutting head of the present invention, resharpening of the cutting insert is not necessary. When there is wear of a cutting profile tool, the cutting insert is released and newly fixed on the holding element in a position offset about an angle. In this new rotational position, the cutting insert has also a cutting profile, which can now be used for machining. It is to be understood that a plurality of cutting profile tools can be accommodated on a body of the cutting insert, for instance when the cutting insert body has arms arranged in star-form (18), wherein one cutting profile tool is arranged to each arm.

After wear of the last cutting profile tool, the entire cutting insert body is to be replaced by another one.

Readjustment of the cutting profile tool in a position of the cutting insert arranged offset about an angle can also be inapplicable when it is taken care that the rotational positions are secured by means of suitable stoppers or the like.

It is to be understood that plural cutting inserts spaced apart in the perimeter direction can also be provided, like in the state of the art, for instance three of them.

The cutting head of the present invention will be advantageously applied for cutting an external thread. Another possible field of application is peeling of workpieces.

According to one embodiment of the present invention, the cutting profile tool is realised in one piece with the cutting insert body. Alternatively, the cutting profile tool can be realised on a separate profile portion, which is detachably attachable to the cutting insert body. For instance, the separate profile portion can be a cutting plate which is attached to the cutting insert body in a suitable manner. On its turn, the cutting plate can be realised as a changeable plate, in order to prolong the overall operation time of the cutting insert.

It has already been indicated that locking means are to be provided on the holding element, in order to lock the cutting insert in the respective rotational position. According to one embodiment of the present invention, the locking means can have a pin, which engages approximately fittingly into the space between neighbouring arms. In the case that the cutting insert is not provided with arms arranged in star-form, bores can be provided in the cutting insert, for instance, which co-operate with a pin on the holding element. Alternatively, the bores can also be provided in the holding element and the pin in the cutting insert.

According to one embodiment of the present invention, the holding element is provided with a first holding portion having the cutting insert, and a second holding portion accommodates the first holding portion. The first holding portion can be fixed on the second holding portion at radial positions out of line. This measure satisfies the demand to use the cutting insert and the cutting head for different diameters of the workpiece.

It has already been clarified that with cutting heads, it is known to shift the cutting insert radially into an inactive position, in order to bring cutting head and workpiece out of engagement. In this context, one embodiment of the present invention provides that the holding element is guided on a ring element of the cutting head along a radial guiding path, a shaft of a cam plate is rotatably mounted in the ring element, and the cam plate co-operates with the holding element in order to move the same radially along the guiding path upon rotation. The shaft of the cam plate is drivable by a drive. Such a drive may be a spring drive for instance, which shifts the cam plate shaft about a certain amount after its actuation and radially shifts the holding element through this. By doing so, the cutting profile tool comes out of engagement with the workpiece. It is to be understood that the spring drive has to be tensioned anew. This may be accomplished either by hand or in a motor driven way. It is also to be understood that the cutting insert is locked in the working position.

The latter embodiment adopts the mechanics of a per se known axial thread rolling head, as is described in DE 44 30 184 A1, the entire contents of which is incorporated herein by reference, for instance. The cylinders or rollers sit on a cam plate shaft, which is rotatable by a tooth wheel gearbox, when a flat spiral spring is released. This arrangement can be coupled with a drive shaft via a claw coupling. The half-couplings are pre-tensioned towards each other, in fact also with the aid of spiral spring. By rotationally shifting the bearing element with respect to the driving shaft, the claw coupling is caught. On the contrary, when a workpiece hits an actuator rod, the half-couplings are brought out of engagement and the spiral flat spring can drive the cam plate shafts and move the rollers radially away from each other, so that the workpiece can be moved out between the same without problems. The cutting head of the present invention can be realised in a similar way as the axial thread rolling head already described above, wherein a front side bearing plate for the cam plate shafts is not necessary, however. For the rest, the mechanics can be realised exactly such as described in DE 44 30 184 A1, the entire contents of which is incorporated herein by reference. However, other axial thread rolling beads have also become known which are based on a comparable principle.

### BRIEF DESCRIPTION OF THE SEVERAL VIEWS OF THE DRAWINGS

In the following, one example of the realisation of the invention will be clarified in more detail by means of drawings.

FIG. 1 shows the front view of a cutting head of the present invention.

FIG. 2 shows a section through the cutting head of FIG. 1 along the line 2-2.

FIG. 3 shows in a perspective side and front view a first embodiment of a cutting insert of the present invention.

FIG. 4 shows in a perspective side and front view a second embodiment of a cutting insert of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

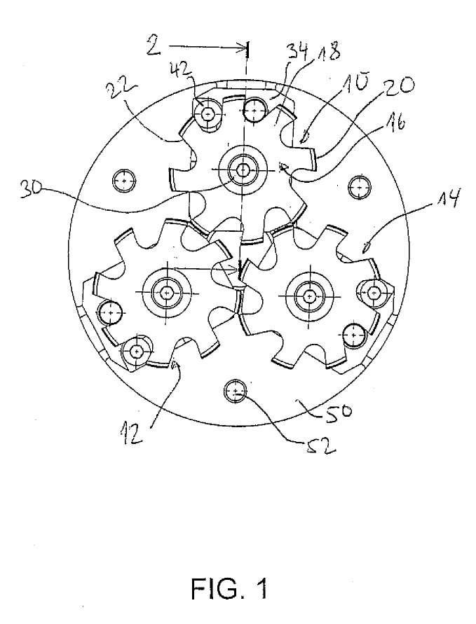

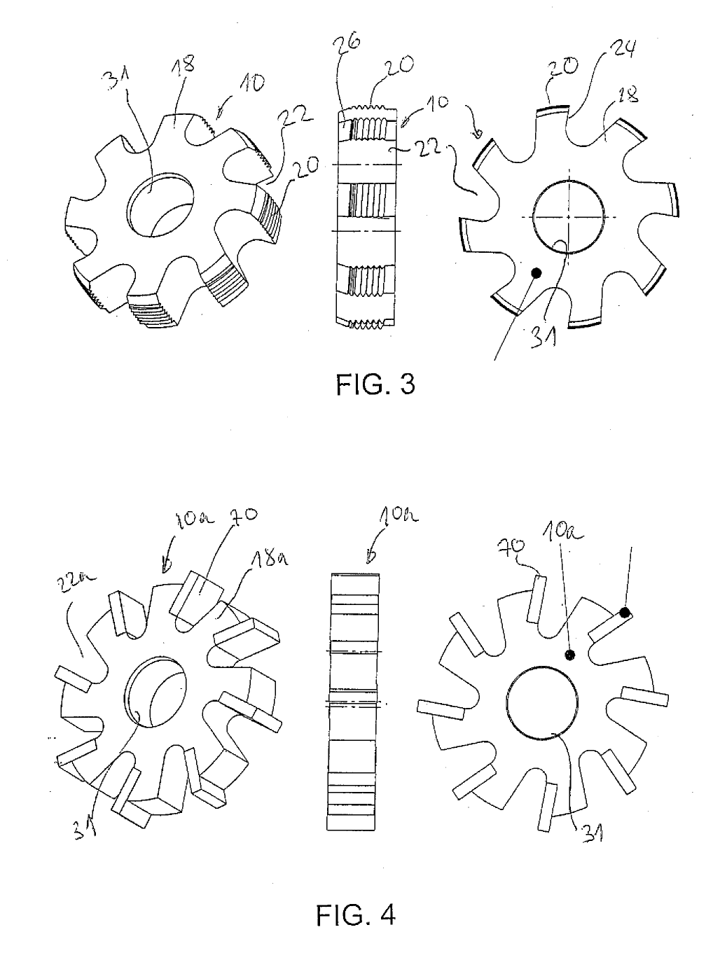

In FIG. 1, three cutting inserts 10, 12 and 14 are shown. A cutting insert body 16 is provided with eight arms 18, which are arranged approximately in star-form and have a tapping profile tool 20 at their outer ends. Thus, the cutting inserts 10 to 14 are similar to the cutting insert shown in FIG. 3. Between the arms 18, there are gaps 22. When machining with a cutting profile tool 20, the flank 24 at the left in FIG. 3 is the face when a relative rotation towards a workpiece (not shown) takes place. The realisation of the tapping profile tool 20 in the axial direction is such that at first, a run-in 26 for the workpiece is provided before the full thread depth is formed. Therefore, the workpiece is supplied from the left side in a cutting insert according to FIG. 3. It is to be understood that when an external thread is formed, only the cutting profile tool 20 of one arm 18 of a cutting insert 10 to 14 is used, as can be recognised from FIG. 1.

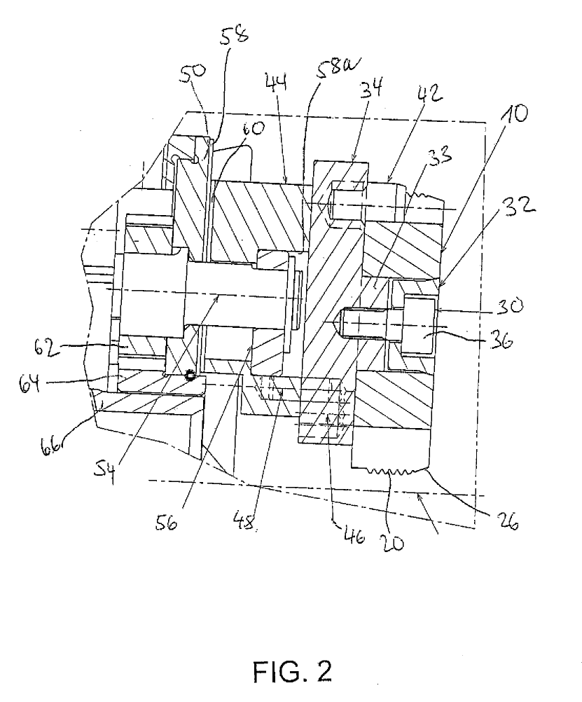

As can be concluded from FIGS. 1 and 2, the three tapping inserts 10 to 14 arranged at equal perimeter distances are fastened on a first holding portion 34 in the axial direction with the aid of a screw 30 via a clamping claw 32. Therefore, the head 36 of the screw is sunk in the clamping claw 32, and thus it does not project towards the outside. A bore 31 of the cutting inserts 10 to 14 accommodates the clamping claw 32, wherein the holding portion 34 has a ring-shaped collar 33 on the opposing side, which engages approximately fittingly into the bore 31.

At the front side, a locking pin 42 is screwed into the holding portion 34, which engages fittingly into the gap 22 of neighbouring arms, in order to fix the respective rotational position of the cutting insert 10. When a tapping profile tool 20 is worn, the cutting insert 20 is detached by unscrewing the screw 30 and fixed anew in a further rotational position, wherein the rotation corresponds to a subdivision of the tapping toolsets 10 to 14. In this position, the tapping insert is fixed anew, so that the cutting head can be used with other cutting profile tools 20. As is obvious, the duration of the operation stop which is necessary to bring another tapping profile tool 20 into operation is relatively short. Any readjustment is not necessary, because precise alignment takes place by driving in the screw 30 and with the aid of the pin 42.

In FIG. 2, it can be recognised that the first holding portion 34 is attached to a second holding portion 44. The attachment is effected with the aid of screws, which are not depicted here. The screws engage into not shown slots of the holding portion 34, in order to fasten the same in relative radial positions with the first holding portion 34. That is to say, the same has radially spaced apart bores 46, with which a pin 48 on the second holding portion 44 co-operates. Thus, a rough radial adjustment of the cutting insert 10 can be performed.

In a ring wheel 50, which is fixed by means of screws 52 on the cutting head, which is not shown for the rest, shafts are rotatably mounted, one of which is shown at 54. The shafts carry a cam plate on their right side end, here cam plate 56, which sits unrotatably on the shaft 54 and engages approximately fittingly into a recess 58 of the second holding portion 44. Therefore, rotation of the shaft 54 results in a radial shift of the holding portion 44, and with it of the holding portion 34 and in turn also of the cutting insert 10. The ring wheel 50 has a dovetail guiding 58 on its right side, with which co-operates a dovetail portion 60 on the facing side of the holding portion 44 when the described radial movement takes place. Instead of a dovetail guiding, another linear guiding can also be provided.

On the other side of the ring wheel 40, a pinion 62 is unrotatably arranged on the shaft 54, which co-operates with a central tooth wheel 64. The tooth wheel sits on a shank 66. When the shank 66 is turned, a rotation of the cam plate shafts is also effected by this.

The mechanism described at least serves for the purpose to bring the cutting inserts 10 to 14, which are each one shiftable in the same way as has been described for the cutting insert 10 in the context of FIG. 2, out of engagement with the workpiece which is machined or to perform a radial fine adjustment, respectively. For the rest, the mechanism indicated here is equivalent to that one which has been disclosed in DE 44 30 184 A1. The shank 66 is brought into rotation by a spring drive, as soon as a not shown spiral flat spring is released, for instance. This releasing is effected in that a claw coupling comes out of engagement, for instance. This bringing out of engagement takes place in that a workpiece, which is to be provided with an external thread, shifts an actuation rod, which separates the coupling claws. Through this, the spiral flat spring can rotate the shank 66 and rotate the cam plate shafts 54, so that the cutting inserts 10 to 14 move radially apart from each other.

With the aid of a measure also described in DE 44 30 184 A1, the spring can be tensioned anew and the clutch-in of the claw coupling can be effected. Through this, the cutting inserts 10 to 14 are brought into the working position for making a further thread portion.

In FIG. 4 is shown that a cutting insert 10a with aims 18a can accommodate cutting plates 70, which can be provided with a cutting profile. The cutting profile is not represented. It may be also a peeling profile or the like instead of a tapping profile. The cutting plates 70 are fastened on the arms 10a in a not shown suitable manner. On their part, they may be changeable plates, i.e. have at least two cutting profiles, as is per se known in the context of other changeable cutting plates.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A rotatingly drivable cutting head with at least one cutting insert, which has a cutting profile tool for radial engagement into a workpiece, the one axis of which is in the rotational axis of the cutting head, wherein cutting head and workpiece are moved axially and in the rotational direction with respect to each other, wherein the cutting insert is detachably attachable on a holding element of the cutting head, wherein further the holding element and with it the cutting insert is radially movable between a working position and a releasing position, and with locking means for positioning the cutting insert in the working position and shifting means for shifting the cutting insert from the working position into the releasing position and vice versa, characterised in that the cutting insert (10, 12, 14, 10a) has an axis which runs parallel to the rotational axis in a distance, the cutting insert (10, 12, 14, 10a) is attachable on the holding element (34, 44) in at least two rotational positions in an angular distance when it is rotated around its axis, and in every rotational position, a cutting profile tool (20) is in the working position on the cutting insert (10, 12, 14, 10a).

2. A cutting head according to claim 1, characterised in that the cutting profile tool (20) is a profile tool for tapping.

3. A cutting head according to claim 1, characterised in that the cutting profile tool (20) is a profile tool for peeling.

4. A cutting head according to claim 1, characterised in that the cutting insert (10, 12, 14, 10a) has arms arranged in star-form (18), on which one cutting profile tool (20) is arranged at a time.

5. A cutting head according to any claim 1, characterised in that the cutting profile tool (20) is realised in one piece with a cuffing insert body (16).

6. A cutting head according to claim 1, characterised in that the cutting profile tool is realised as a separate profile portion (70), which is detachably or not detachably attachable to a cutting insert body.

7. A cutting head according to claim 1, characterised in that the cutting insert (10, 12, 14, 10a) is attachable on the holding element (34, 44) with the aid of an axial screw (30).

8. A cutting head according to claim 1, characterised in that locking means are provided on the holding element, which lock the cutting insert in the respective rotational position.

9. A cutting head according to claim 1, characterised in that the locking means are constituted by a pin (42) on the holding element, which engages approximately fittingly into the space (22) between neighbouring arms (18).

10. A cutting head according to claim 1, characterised in that the holding element has a first holding portion (34) accommodating the cutting insert (10, 12, 14, 10a), and a second holding portion (44) accommodating the first holding portion (34), and that the first holding portion (34) can be fixed on the second holding portion (44) at different radial positions.

11. A cutting head according to claim 10, characterised in that the second holding portion (44) has a pin (48), which co-operates with bores (46) of the first holding portion (34) which are arranged out of line in the radial direction.

12. A cutting head according to claim 1, characterised in that the holding element is guided on a ring element (50) of the cutting head along a radial guiding path, at least one shaft (54) of a cam plate (56) is rotatably mounted in the ring element (50), the cam plate (56) co-operates with the holding element in order to move the same radially along the guiding path (58) upon rotation, and the shaft (54) is drivable by a drive via a gearbox (64, 62).

13. A cutting head according to claim 12, characterised in that the drive is a spring drive such that upon its actuation, the cutting insert (10, 12, 14, 10a) is moved into the releasing position, wherein the shifting means pre-stress the spring drive when the cutting insert is shifted into the working position, and the locking means lock the holding element in the working position.

14. A cutting head according to claim 1, characterised in that the guiding path (58) has a dovetail cross section which co-operates with a dovetail portion (60) of the holding element (44).

15. A cutting head according to claim 10, characterised in that the cam plate (56) engages approximately fittingly into a slot (58a) of the second holding portion (44).

16. A cutting insert for a rotatingly drivable cutting head, which has a rotational axis, wherein the cutting insert has a cutting profile tool for radial engagement into a workpiece, characterised in that the cutting insert (10, 12, 14, 10a) has an axis, the cutting insert (10, 12, 14, 10a) has means for being attached to the cutting head in at least two rotational positions in an angle distance through a rotation around its axis, and one cutting profile tool is assigned to each rotational position of the cutting insert (10, 12, 14, 10a).

17. A cutting insert according to claim 16, characterised in that the cutting profile tool (20) is a profile tool for tapping.

18. A cutting insert according to claim 16, characterised in that the cutting profile tool (20) is a profile tool for peeling.

19. A cutting insert according to claim 16, characterised in that the cutting insert (10, 12, 14, 10a) has arms arranged in star-form (18), on which one cutting profile tool (20) is arranged at a time.

20. A cutting insert according to any claim 16, characterised in that the cutting profile tool (20) is realised in one piece with a cutting insert body (16).

21. A cutting insert according to claim 16, characterised in that the cutting profile tool is realised as a separate profile portion (70), which is detachably or not detachably attachable to a cutting insert body.
